(19) United States
(12) Patent Application Publication
(10) Pub. No.: US 2025/0140916 A1
(43) Pub. Date: May 1, 2025

(54) PRINTED LAYERS FOR ENCAPSULATION AND REDISTRIBUTION IN SOLID STATE BATTERIES, AND METHODS OF MAKING AND USING THE SAME

(71) Applicants: Arvind KAMATH, Los Altos, CA (US); Shila ALAVI, San Jose, CA (US); Khanh TRAN, San Jose, CA (US); Mihalis MICHAEL, El Dorado Hills, CA (US); Yasumasa MORITA, San Jose, CA (US)

(72) Inventors: Arvind KAMATH, Los Altos, CA (US); Shila ALAVI, San Jose, CA (US); Khanh TRAN, San Jose, CA (US); Mihalis MICHAEL, El Dorado Hills, CA (US); Yasumasa MORITA, San Jose, CA (US)

(73) Assignee: Ensurge Micropower ASA, Oslo (NO)

(21) Appl. No.: 18/925,892

(22) Filed: Oct. 24, 2024

Related U.S. Application Data
(60) Provisional application No. 63/593,508, filed on Oct. 26, 2023.

(51) Int. Cl. H01M 10/0562; H01M 4/04; H01M 4/134; H01M 4/66; H01M 10/0525; H01M 10/0585; H01M 50/417; H01M 50/449

(52) U.S. Cl. CPC H01M 10/0562; H01M 4/0402; H01M 4/134; H01M 4/661; H01M 10/0525; H01M 10/0585; H01M 50/417; H01M 50/449

(57) ABSTRACT

A solid-state battery cell and a method of making the same are disclosed. The battery cell includes a substrate, a cathode on or over the substrate, a solid-state electrolyte on the cathode, an anode current collector (ACC) on the solid-state electrolyte, a conductive bump on the ACC, an insulator layer on the ACC and having a sidewall portion, and a conductive redistribution layer in ohmic contact with the conductive bump and on the insulator layer, including the sidewall portion. The insulator layer surrounds the conductive bump and exposes a surface of the conductive bump. The method includes printing the conductive bump on the ACC, printing the insulator layer on the ACC and a sidewall of the ACC, solid-state electrolyte, cathode and substrate, and forming the conductive redistribution layer on the exposed conductive bump and the insulator layer, including the sidewall portion.

### CROSS-REFERENCE TO RELATED APPLICATIONS

This application claims the benefit of U.S. Provisional Pat. Appl. No. 63/593,508, filed Oct. 26, 2023, pending, incorporated herein by reference in its entirety.

### FIELD OF THE INVENTION

The present invention generally relates to the field of solid-state and/or thin film batteries. More specifically, embodiments of the present invention pertain to printed layers for encapsulation and redistribution in solid-state batteries, and methods of making and using the same.

### DISCUSSION OF THE BACKGROUND

Solid-state lithium batteries are ionic-charge storage devices that are ideally suited for wearable, IoT, and other non-EV applications due to their small size, safety, and high cyclability. To retain high cycle life, the battery cell must be shielded from ambient ingress, to prevent lithium loss due to undesirable reactions with chemical species in air (e.g., dioxygen, water vapor) during charge cycling.

At the cell level, one solution is to deposit a protection layer. However, this layer is typically cut or diced through during subsequent device singulation, thereby rendering potential entry paths for ambient ingress of gas-phase species through gaps in the sidewalls of the battery. Another method is to package the cell inside a pouchcell or by sandwiching it inside a moisture-resistant laminate. These assembly methods, however, add packaging overhead, thereby reducing the charge capacity per package area and package volume.

Thus, a better solution is needed to provide a reasonably robust ambient protection with low packaging overhead.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

The present invention relates to solid-state and thin film batteries, and more specifically to a solid-state battery and methods of making and using the same. The present invention uses printing (e.g., digital inkjet printing) of insulators and (optionally) metals to provide ultrathin, maskless, fine registration and fast manufacturing cycle times. Printing certain layers in the battery also eliminates any need for laser vias or patterned vias to make intra-or inter-layer connections.

In one aspect, the present invention relates to a solid-state battery cell, comprising a substrate, a cathode on or over the substrate, a solid-state electrolyte on the cathode, an anode current collector (ACC) on the solid-state electrolyte, a conductive bump on the ACC, an insulator layer on the ACC and having a sidewall portion, and a conductive redistribution layer in ohmic contact with the conductive bump and on the insulator layer, including the sidewall portion. The insulator layer surrounds the conductive bump and exposes a surface of the conductive bump, and the sidewall portion is on a sidewall of each of the ACC, the solid-state electrolyte, the cathode and the substrate.

In various embodiments, the conductive bump has a height that is greater than the thickness of the insulator layer. For example, the thickness of the insulator layer may be 40-80% of the height of the conductive bump.

In other or further embodiments, the substrate comprises a metal foil, film or sheet. When substrate comprises the metal foil, the metal foil may have a thickness of 0.1-100 μm. The metal foil may comprise stainless steel, aluminum, copper, nickel, inconel, brass, molybdenum or titanium, for example, and the aluminum, copper, nickel, molybdenum or titanium may be alloyed with up to 10% of one or more other elements to improve one or more physical and/or chemical properties thereof. The metal foil, film or sheet may further comprise a single-or multi-layer barrier on one or more major surfaces. The barrier generally has a thickness effective to prevent migration of atoms or ions from the metal foil into overlying layers. For example, the barrier may have a thickness of 0.05-3 μm. In various examples, the barrier comprises one or more layers of a glass, a ceramic, a refractory metal nitride, or an amorphous metal or metal alloy.

In various embodiments, the cathode may comprise a lithium metal oxide or lithium metal phosphate, the solid-state electrolyte may comprise a lithium phosphorus oxynitride or Li₂WO₄, and the ACC may comprise nickel, zinc, copper, an alloy thereof, or graphite.

In other or further embodiments, the conductive bump may comprise an electrically conductive metal or solder, or an electrically conductive graphite, and the insulator layer may comprise a polyolefin and/or an inorganic oxide layer, such as an oxide or oxynitride of silicon and/or aluminum.

In some embodiments, the solid-state battery cell may further comprise a moat in the cathode and the solid-state electrolyte, surrounding the ACC and configured to physically separate an active portion of the battery cell from a peripheral dummy region of the battery cell. The moat may completely penetrate the cathode and the solid-state electrolyte, and may have a width of 3-20 μm.

Another aspect of the present invention relates to a packaged solid-state battery, comprising a plurality of the present solid-state battery cells, an adhesive layer between adjacent ones of the solid-state battery cells, a first terminal in electrical contact with the conductive redistribution layer on the sidewall portion of the insulator layer (e.g., on an “ACC edge” of the battery cells), and a second terminal in electrical contact with an exposed surface of the substrate (e.g., on a cathode current collector side, or “CCC edge,” of the battery cells). As for the present solid-state battery cells, the substrate may comprise a metal foil, film or sheet, and the exposed surface of the metal foil, film or sheet is a sidewall of the metal foil, film or sheet. In such a configuration, the metal foil, film or sheet can function as the cathode current collector (CCC).

Yet another aspect of the present invention relates to a method of making a solid-state battery cell, comprising printing a conductive bump on an anode current collector (ACC) on a solid-state electrolyte, printing an insulator layer on the ACC such that the insulator layer surrounds the conductive bump and exposes a surface of the conductive bump, and forming a patterned conductive redistribution layer on the exposed conductive bump and the insulator layer. The solid-state electrolyte is on a cathode, and the cathode is on or over a substrate. The insulator layer is also printed on a sidewall of each of the ACC, the solid-state electrolyte, the cathode and the substrate. The conductive redistribution layer is in ohmic contact with the conductive bump, and is also formed on at least a portion of the insulator layer along the sidewalls of the ACC, the solid-state electrolyte, the cathode and the substrate.

In various embodiments, printing the conductive bump may comprise screen printing, inkjet printing, stencil printing, gravure printing, or flexographic printing a conductive paste, resin or solder. In such embodiments, the method may further comprise curing the conductive paste, resin or solder to form the conductive bump.

In other or further embodiments, the insulator layer may be printed in a pattern on the ACC and the sidewall of each of the ACC, the solid-state electrolyte, the cathode and the substrate. The pattern may comprise an opening having an area larger than that of the conductive bump.

In some embodiments, forming the patterned conductive redistribution layer comprises sputtering, atomic layer deposition (ALD) or thermal evaporation of an air- and/or water-stable metal through a mask, and removing the mask. In other embodiments, forming the patterned conductive redistribution layer comprises blanket depositing an air- and/or water-stable metal on the exposed conductive bump and the insulator layer, photolithographically patterning the metal, and etching the metal. In further alternative embodiments, forming the patterned conductive redistribution layer comprises selectively depositing the patterned conductive redistribution layer on the exposed conductive bump and the insulator layer. Selectively depositing the patterned conductive redistribution layer may comprise, for example, inkjet printing, aerosol-jet printing or screen printing an ink or a paste of a precursor of the conductive redistribution layer, and curing the ink or the paste. In any or all of these embodiments, the conductive redistribution layer may comprise an air-and water-stable, lithium-compatible metal, such as Cu, Ni, or Al.

In further embodiments, the method may further comprise patterning the ACC prior to printing the conductive bump. Additionally or alternatively, the method may further comprise blanket-depositing the cathode on or over the substrate, blanket-depositing the solid-state electrolyte on the cathode, and forming the ACC on the solid-state electrolyte. In the latter case, forming the ACC may comprise forming a patterned ACC.

The present method of making a solid-state battery cell can be performed on a large scale, for example on a metal sheet or on a roll of metal foil. Thus, the present method may make an n×m array of the solid-state battery cells, where n is the number of rows of cells on the sheet or roll, m is the number of columns of cells on the sheet or roll, and n and m are each independently a positive integer of 2 or more (e.g., 3, 4, 5, 6, 8, 10, 12, 16, 18, etc.). When the solid-state battery cells are manufactured on a roll, the roll may have a length of 10 m or more (e.g., 25 m, 40 m, 50 m, 75 m, 100 m, 150 m, 200 m, 250 m, 300 m, etc.), in which case m can be 400 or more, 1000 or more, 2000 or more, 5000 or more, 10,000 or more, 20,000 or more, 30,000 or more, 50,000 or more, 100,000 or more, etc. The present method is very well-suited for manufacturing solid-state battery cells and batteries by roll-to-roll (R2R) processing.

The present method results in a solid-state battery that has a relatively high active battery area utilization, thereby maximizing battery energy density, and relatively low manufacturing cost. Other capabilities and advantages of the present invention will become readily apparent from the detailed description of various embodiments below.

### BRIEF DESCRIPTION OF THE DRAWINGS

FIGS. 1-9 are cross-sectional views of various structures in an exemplary method of manufacturing solid-state battery cells, according to embodiments of the present invention.

FIGS. 10-13B show plan (top-down) and cross-sectional views of structures formed in an exemplary method of making solid-state battery cells according to one or more alternative embodiments of the present invention.

FIG. 14 is a side or cross-sectional view of multiple battery cells of FIG. 9 in a stack, according to embodiments of the present invention.

FIG. 15 is a cross-sectional or perspective view of an exemplary packaged battery according to one or more embodiments of the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. Furthermore, it should be understood that the possible permutations and combinations described herein are not meant to limit the invention. Specifically, variations that are not inconsistent may be mixed and matched as desired.

The technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

For the sake of convenience and simplicity, the term “length” generally refers to the largest dimension of a given 3-dimensional structure or feature. The term “width” generally refers to the second largest dimension of a given 3-dimensional structure or feature. The term “thickness” generally refers to a smallest dimension of a given 3-dimensional structure or feature. The length and the width, or the width and the thickness, may be the same in some cases. A “major surface” refers to a surface defined by the two largest dimensions of a given structure or feature, which in the case of a structure or feature having a circular surface, may be defined by the radius of the circle.

In addition, for convenience and simplicity, the terms “part,” “portion,” and “region” may be used interchangeably but these terms are also generally given their art-recognized meanings. Also, unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

The present invention concerns a solid-state battery containing a printed encapsulation and/or redistribution layer and methods of making the same. The present solid-state battery includes, in some embodiments, an intrinsic anode-less battery comprising a substrate (which can also serve or function as a cathode current collector [CCC]), a cathode or cathode layer, a solid-state electrolyte (SSE) or solid-state electrolyte layer, and an anode current collector (ACC). In anode-less embodiments, no lithium anode is formed between the SSE and the ACC during manufacturing. A lithium anode may form during or upon completion of a battery charging operation.

The following discussion provides an example of a manufacturing process for solid-state batteries and stacked solid-state batteries, as well as variations of the process.

### An Exemplary Method of Making a Solid-State Battery

FIGS. 1-9 show certain structures in an exemplary method of making a solid-state battery. FIG. 1 shows a substrate 100, comprising a metal foil, sheet or film 110 and optional first and second barriers 115a-b on opposite major surfaces of the metal foil, sheet or film 110. When the foil, sheet or film 110 is a metal foil, the first and second barriers 115a-b are not optional. The metal foil may comprise or consist essentially of stainless steel, aluminum, copper, nickel, inconel, brass, molybdenum or titanium, the elemental metals of which may be alloyed with up to 10% of one or more other elements to improve one or more physical and/or chemical properties thereof (e.g., oxygen and/or water permeability, flexibility, resistance to corrosion or chemical attack during subsequent processing, etc.). However, the sheet or film can also be a metal sheet or metal roll. For example, the foil or film may be 0.1-100 μm thick, or any thickness or range of thicknesses therein (e.g., 1-50 μm, 5-30 μm, etc.), whereas a metal sheet generally has a thickness of >100 μm, up to about 1-2 mm, although the invention is not so limited. Other alternative substrates include a metal coating on a mechanical substrate, such as aluminum, copper, nickel, titanium, etc., on a removable film, sheet or roll of an organic polymer (e.g., plastic).

The barrier 115a-b comprises one or more layers of one or more materials in a thickness effective to prevent migration of atoms or ions from the metal foil, sheet or film 110 into overlying layers. The barrier material(s) may comprise a glass or ceramic, such as silicon dioxide, aluminum oxide, silicon nitride, a silicon and/or aluminum oxynitride, etc., a (refractory) metal nitride, such as aluminum nitride, titanium nitride, titanium aluminum nitride, tungsten nitride, titanium tungsten nitride, tantalum nitride, etc., or an amorphous metal or metal alloy, such as a TiW alloy. In some embodiments, each of the first and second barriers 115a-b comprises alternating glass/ceramic and metal nitride layers (e.g., a first metal nitride layer, a first glass/ceramic layer, and a second metal nitride layer, which may further comprise a second glass/ceramic layer, a third metal nitride layer, etc.). Each barrier 115a or 115b, whether a single layer or multiple layers, may have a total thickness of 0.05-3 μm, but the barrier 115 is not limited to this range. The barriers 115a-b may be blanket-deposited onto the foil, sheet or film 110 by chemical or physical vapor deposition (e.g., sputtering, thermal evaporation, atomic layer deposition [ALD], etc.), solution-phase coating with a precursor material followed by annealing to form the glass/ceramic or metal nitride, etc. Exemplary barrier materials, structures and thicknesses and methods for their deposition are disclosed in U.S. Pat. Nos. 9,299,845 and 11,742,363 and U.S. patent application Ser. No. 17/012,010, filed Sep. 3, 2020 (Atty. Docket No. IDR5320), the relevant portions of each of which are incorporated by reference herein.

In some embodiments, the foil, sheet or film 110 functions as a cathode current collector. In such embodiments, at least the barrier 115a (and optionally the barrier 115b) is a conductive, amorphous material, such as the refractory metal nitrides listed above or an amorphous metal alloy (e.g., a TiW alloy).

FIG. 2 shows the metal substrate 100 with a cathode 120 thereon. The cathode 120 may comprise a lithium metal oxide or lithium metal phosphate, such as lithium cobalt oxide (LiCoO₂; LCO), lithium manganese oxide (LiMn₂O₄; LMO), or lithium iron phosphate (LiFePO₄; LFP), for example. The cathode 120 may be blanket deposited by laser deposition (e.g., pulsed laser deposition or PLD), sputtering, chemical vapor deposition (CVD), sol-gel processing, etc. Alternatively, the cathode 120 may be selectively deposited by screen printing, inkjet printing, spray coating, or extrusion coating (e.g., using an ink comprising one or more sol-gel precursors and one or more solvents, having a viscosity appropriate for the printing or coating technique).

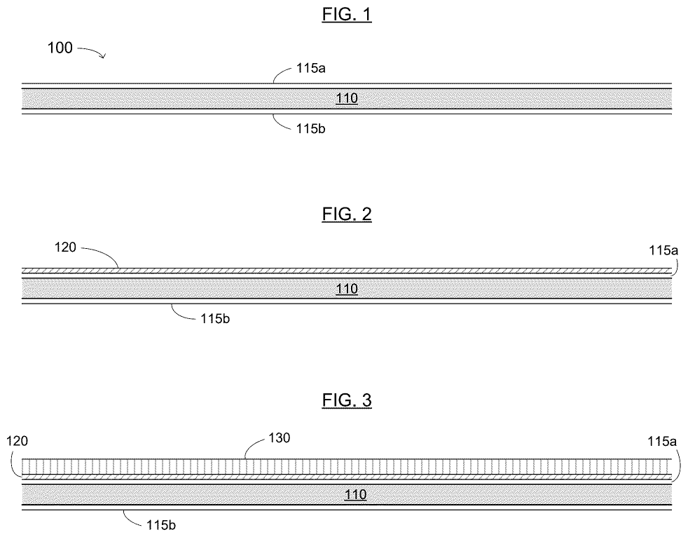

FIG. 3 shows a solid-state electrolyte 130 on the cathode 120. The electrolyte 130 may comprise or consist essentially of a conventional lithium phosphorus oxynitride (LiPON, which may optionally be carbon-doped) or Li₂WO₄, a good Li-ion conductor. Alternatively, the electrolyte 130 may comprise lithium lanthanum zirconium oxide (LLZO). Typically, the electrolyte 130 is a continuous layer or thin film. In some embodiments, the electrolyte 130 may further comprise optional cathode and/or anode interface layers (not shown), each of which may comprise a lithiated metal oxide (see, e.g., U.S. Pat. No. 11,735,791, the relevant portions of which are incorporated herein by reference).

Forming the electrolyte 130 may comprise depositing a LiPON layer or a tungsten oxide layer of the formula WO₃₊ₓ (0≤x≤1) by sputtering, optionally using pulsed DC power. When the electrolyte 130 comprises LiPON, it may be deposited by RF sputtering or ALD. The sputtering target may comprise a Li₃PO₄ or mixed graphite-Li₃PO₄ target, the latter of which may contain 1-15 wt % of graphite, when the electrolyte 130 comprises LiPON or carbon-doped LiPON, and a metallic/elemental tungsten target when the electrolyte 130 comprises a tungsten oxide. In the latter case, sputtering is performed in an oxygen or oxygen-containing atmosphere. The method of making the electrolyte 130 may further comprise lithiating and thermally annealing the WO₃₊ₓ, which can transform it into Li₂WO₄, a good Li-ion conductor. Lithiating may comprise wet lithiation (e.g., immersing the WO₃₊ₓ in a solution containing a lithium electrolyte such as LiClO₄, LiPF₆, LiBF₄, etc., and applying an appropriate electric field) or dry lithiation (e.g., sputtering or thermally evaporating elemental lithium onto the tungsten oxide in a vacuum chamber, optionally while heating the substrate 100). Thermal annealing may comprise heating at a temperature of 150-500° C. for a length of time of 5-240 minutes, or any temperature or length of time therein (e.g., 250-450° C. for 10-120 minutes), in a conventional oven, a vacuum oven, or a furnace. To ensure substantially complete diffusion of the lithium into and/or throughout the WO₃₊ₓ, the WO₃₊ₓ should be annealed (preferably in air) at a temperature of at least 100° C. for at least 10 minutes (e.g., to transform it into Li₂WO₄).

FIG. 4 shows a number of anode current collectors (ACCs) 140a-d on the electrolyte 130, thus forming substantially complete (but unsealed) cells. A separately-formed anode is not necessary in solid-state lithium batteries, as a lithium anode can be formed between the electrolyte 130 and the anode current collectors 140a-d during charging, if necessary. Optionally, however, a thin lithium anode can be deposited by evaporation onto the electrolyte 130 prior to formation of the anode current collectors 140a-d.

The anode current collectors 140a-d generally comprise a conductive metal, such as nickel, zinc, copper, alloys thereof (e.g., NiV), etc., or another conductor, such as graphite. The anode current collectors 140a-d can be selectively deposited by screen printing, inkjet printing, spray coating, etc. Typically, the printed anode current collectors 140a-d are cured by irradiating with ultraviolet (UV) light, heating (e.g., up to a temperature of about 550° C., but more commonly, up to about 400° C.), or a combination thereof. Alternatively, the anode current collectors 140a-d may be formed by blanket deposition (e.g., sputtering or evaporation) and patterning (e.g., low-resolution photolithography, development and etching). The anode current collectors 140a-d may have a thickness of 0.1-5 μm, although it is not limited to this range.

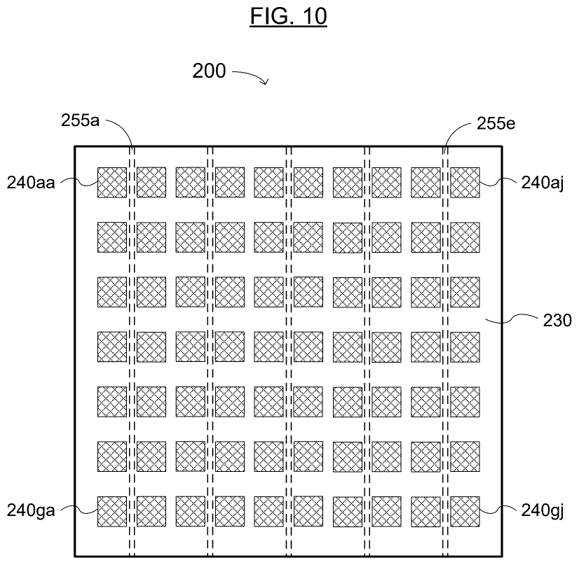

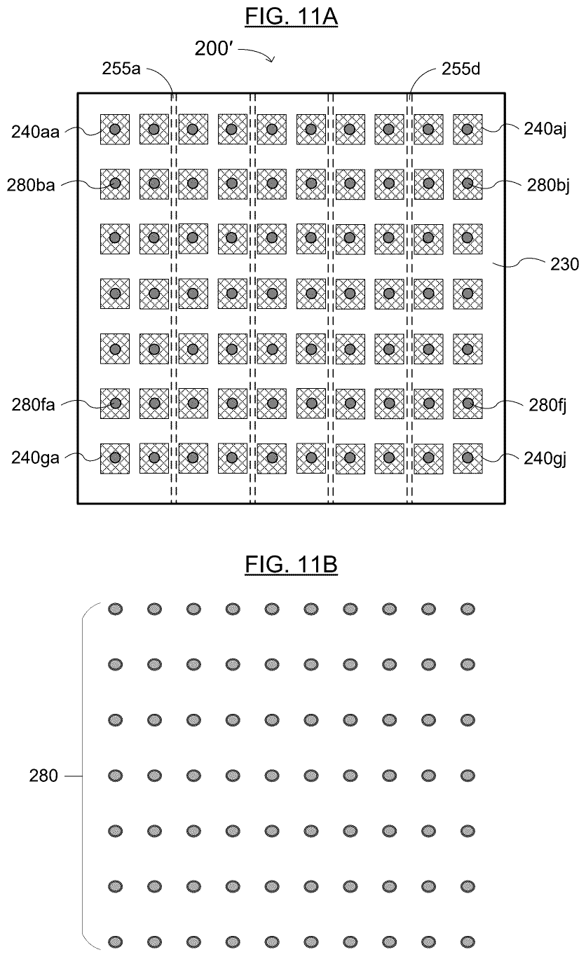

The anode current collectors 140a-d may have area dimensions (i.e., length and width dimensions) that are 50-95% of the corresponding length and width dimensions, respectively, of the cell (see e.g., FIGS. 8 and 10), although the borders of the anode current collectors 140a-d may be offset (pulled back) a relatively small or minimal distance from the ultimate cell borders, in some embodiments. The pull-back distance of the ACCs 140a-d from the cell edges should be sufficient to electrically isolate the ACCs 140a-d from the CCC/substrate 100.

The cells may further include one or more interlayers that modify the interfaces between layers. For example, a metal oxide (e.g., Nb₂O₅, Al₂O₃, Li₄Ti₅O₁₂ or LiNbO₃) interlayer may be formed on the cathode 120 prior to deposition of the electrolyte 130 (e.g., to reduce interfacial stress, decrease interfacial resistance, or suppress formation of a space charge layer). An amorphous (e.g., elemental silicon) interlayer may be deposited on the electrolyte 130 prior to formation of the anode current collectors 140a-d to inhibit reduction of the electrolyte. Of course, the battery cell can be made in the reverse order (i.e., the anode current collector may be first formed on the substrate, then the remaining layers deposited in reverse order thereon).

An advantage of the present method is that some/all of the active battery layers (e.g., the cathode 120 and the solid-state electrolyte 130) are deposited as blanket layers. This maximizes the active area utilization of the battery cells for high intrinsic capacity, and also results in a topographically planar or “flat” cell to facilitate formation of the uppermost layer(s) and downstream packaging due to the pattern-free blanket-deposited layers. However, if necessary or desired, the cathode 120 and the SSE 130 can be slightly pulled back from the cell edge by subtractive patterning (e.g., low-resolution photolithography, laser ablation) or selective deposition (as described herein).

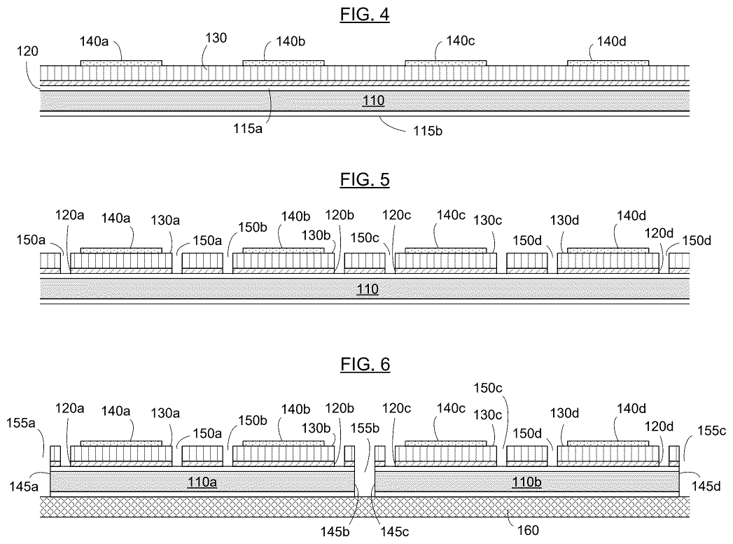

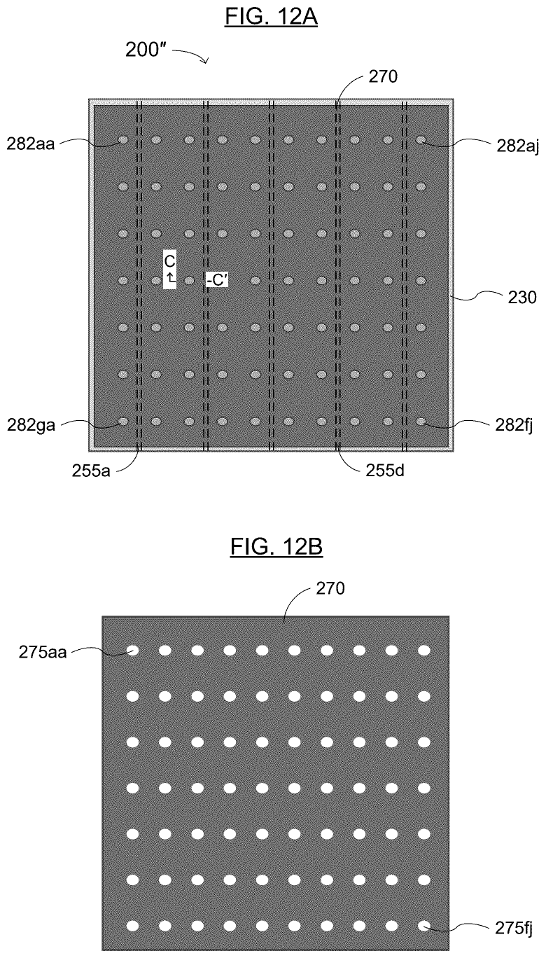

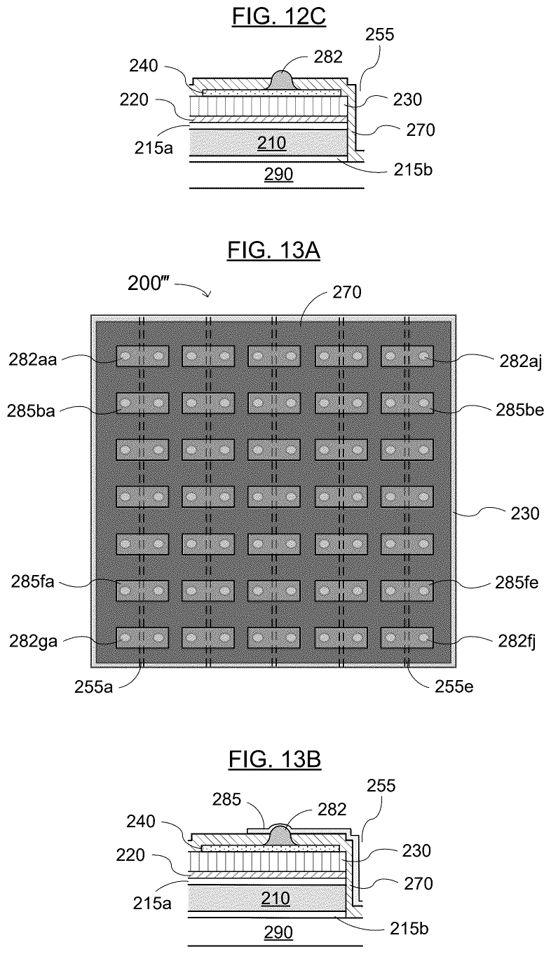

FIGS. 5-9 show intermediate structures in a process for moat formation, ACC-edge electrical isolation and cell encapsulation, followed by formation of an interconnect/via and redistribution layer for contact with the anode current collector 140. FIG. 5 in particular shows formation of moats 150a-d. In the present invention, however, the moats 150a-d and their formation are optional (see, e.g., FIGS. 12C and 13B).

After cell fabrication as described above, FIG. 5 shows the devices receiving a shallow cut through both of the cathode 120 and the solid-state electrolyte 130 (and optionally slightly into the substrate 100) in a region of the cells outside of the ACCs 140a-d to form moats 150a-d that completely surround the respective ACCs 140a-d. The moats 150a-d may be formed by laser ablation, mechanical dicing, or low-resolution photolithographic patterning (e.g., of a photoresist or other mask material) and etching. The moats 150a-d may have a width of 3-20 μm, although the invention is not limited to such widths. The moats 150a-d provide an anchoring feature for cell encapsulation (see the discussion below with regard to FIG. 7) and physically separate the active portion(s) of the battery layers from a peripheral dummy region. When the moats 150a-d extend into the substrate 100, they fully isolate the active cathode and electrolyte layers 120 and 130. Each of these aspects of the moats 150a-d also increases resistance to ambient ingress (e.g., of air, moisture, etc.).

Referring to FIG. 6, the substrate 100 may be attached to a tape or sheet 160, and the electrolyte 130, the cathode 120 and the substrate 100 are cut or diced along the “ACC edges” 145a-d of the battery cells to form an opening 155a-c every other cell, or every other row or column of cells (when the cells are in an array or on a multi-column roll). This step is also optional in the present invention. The tape or sheet 160 is generally a UV release tape or sheet, containing an adhesive on one or both major surfaces that loses its adhesive properties upon sufficient irradiation with ultraviolet (UV) light. The tape or sheet 160 may be on a ring or other frame, configured to mechanically support the tape or sheet 160 and allow some tension therein. The ACC cell edges 145a-d may result from a cut by laser (e.g., laser ablation), mechanical dicing or stamping, for example. Exemplary mechanical dicing and stamping processes are disclosed in U.S. patent application Ser. No. 18/885,525, filed Sep. 13, 2024 (Atty. Docket No. IDR2022-06), the relevant portions of which are incorporated herein by reference.

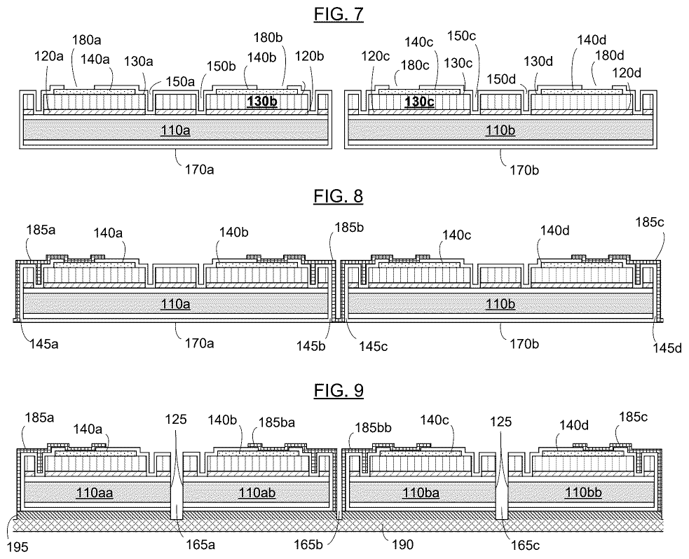

When the cells are in an array or on a multi-column roll, they may also be cut or diced along the x-direction in FIG. 6 between adjacent cells (e.g., every column, or every row) to form isolated cell pairs. The cuts along the x-direction may be made in the same process or a different process. For example, when the cuts are made by laser, the cuts in the z-direction (as shown) and in the x-direction may be made in the same process (e.g., a continuous dicing process), and when the cuts are made by mechanical dicing or stamping, the cuts in the x-direction are typically made in a separate process from those made in the z-direction. The sidewalls 145a-d along the cuts fully expose the entire cell stack, including the CCC/substrate 110. In a further option, the electrolyte 130, the cathode 120 and the substrate 100 in the region or area between adjacent moats 150 not containing an ACC 140 are also cut or diced (see, e.g., FIG. 9, which shows the further cuts resulting in “CCC edges” 125).

Referring now to FIG. 7, after the diced cell pairs are released from the tape or sheet 160, the cell pairs are substantially encapsulated with a mechanically compliant moisture barrier and electrical insulation film 170a-b. The barrier/insulation film 170a-b also lines the inner surfaces of the moats 150a-d to provide further electrical isolation and moisture barriers to protect the battery cells. The barrier/insulation film 170a-b may cover the front or uppermost surface of the cells, and optionally, the back and the “ACC” side surface of the cells. The barrier/insulation film 170a-b is printed (e.g., by inkjet printing or screen printing) onto the cells. The barrier/insulation film 170a-b may comprise parylene, polyethylene, polypropylene, or another polyolefin, with or without a thin, printable inorganic oxide overlayer such as SiO₂ (e.g., formed by heating a tetraalkyl silicate such as tetraethyl orthosilicate [TEOS]). The material(s) of the barrier/insulation film 170_{a-b} may be dissolved or suspended in an appropriate solvent (e.g., an organic solvent, as described elsewhere herein) prior to printing. In certain embodiments, after printing, the material for the barrier/insulation film 170a-b may be cured (e.g., by irradiation with ultraviolet light and or heating,, as described herein) to provide certain desirable properties (e.g., hardness, optical properties, adhesion, etc.).

One advantage of printing to form the barrier/insulation film 170a-b is that an opening 180a-d may be formed on each cell over the ACC 140 during printing, without any need for additional processing (such as laser ablation, photolithographic patterning, etc.) to form the openings. Another advantage of printing is that, if further cuts resulting in “CCC edges” 125 are made prior to encapsulation, such edges can be selectively not covered with the barrier/insulation film 170a-b by simply not printing the barrier/insulation film 170a-b on those edges.

FIG. 8 shows formation of redistribution metal layers 185a-c along the ACC edges 145a-d and in vias or openings 180a-d in the barrier/insulation films 170a-b to connect the ACCs 140a-d to a subsequently formed external battery terminal (e.g., an anode). The redistribution layers 185a-c may comprise Cu, Ni, Al, or another suitable and/or stable (e.g., air-and/or water-stable, and/or lithium-compatible) metal, and may be formed by sputtering, ALD or thermal evaporation (e.g., through a mask that exposes a region of the cell corresponding to the pattern of the redistribution layers 185a-c, followed by removal of the mask, or by blanket deposition, followed by photolithographic patterning and etching), or by selective deposition, such as inkjet printing, aerosol-jet printing or screen printing. Printing may comprise use of a conventional metal-containing ink or paste.

Low electrical resistance and a low curing temperature are desirable for the redistribution layers 185a-c, and the redistribution layers 185a-c have a thickness typically in the range 0.25-2 μm on the uppermost surface of the cells. For example, regardless of how the redistribution layers 185a-c are deposited, the redistribution layers 185a-c may be cured (e.g., by heating or sintering, optionally after drying in the case of printing an ink or paste) at a temperature of 150-550° C., or any temperature or range of temperatures therein (e.g., 150-350° C.), for a length of time sufficient to convert the deposited material to a conductive metal. Due to liquid flow (e.g., when the redistribution layers 185a-c are printed), the entireties of the vias or openings 180a-d, which may be beneficial during battery cycling. When the moats 150 are present, deposition of the redistribution layers 185a-c by printing, sputtering, or thermal evaporation may also fill the portions of the moats 150 nearest to the ACC edges 145a-d with metal, facilitating the ingress-barrier function of the moat 150 along the ACC edge 145.

A single redistribution layer (e.g., 185b) is on the ACC edges 145a-d of adjacent cells. The redistribution layers (or ACC redistribution traces) 185a-c go from the ACCs 140a-d exposed through the vias or openings 180a-d to the ACC edges 145a-d, in the opposite direction from the CCC edges 125 (FIG. 9), and across the openings 155a-c. In a plan view (not shown), the redistribution layers 185a-c may be formed or deposited individually across a cell pair, or alternatively, along an entire column of cell pairs (e.g., in a strip).

The ACC redistribution traces 185a-c electrically contact the ACCs 140a-d through the vias 180a-d, but are physically and electrically insulated from the CCCs/substrates 110a-b by the barrier/insulation films 170a-b. When the ACC redistribution traces 185a-c are a metal, they form an intrinsic barrier to ambient ingress in the region of the vias or openings 180a-d. The ACC redistribution traces 185a-c are both physically on the top surface of the cell and covering at least part of the corresponding sidewalls 145a-d. The ACC redistribution traces 185a-c on the sidewalls 145a-d enable electrical connection to the cells through a terminal on the side of the battery at a later stage of the method.

In some embodiments, the method comprises printing both the insulator for the barrier/insulation film 170a-b and the metal (e.g., the ACC redistribution traces 185a-c, and optionally, the ACCs 140a-d), using dual (separate) inkjet printer heads. Preferably, the materials for the barrier/insulation film 170a-b and the ACC redistribution traces 185a-c are printed separately, with an optional curing step between the separate printing steps, if necessary or desired, although they may be printed simultaneously in some cases (e.g., where the solvents for the different layers are immiscible). This allows for faster cycle times and more efficient use of capital for manufacturing equipment.

FIG. 9 shows singulated cells (or columns of cells) on substrates 110aa, 110ab, 110ba and 110bb. Prior to singulation (dicing), the cell pairs may be placed on an epoxy-coated tape 190/195. In this case, dicing along the CCC edges 125 (to form openings 165a-c) creates the single cells or single columns of cells. Alternatively, dicing along the CCC edges 125 can be performed at the same time as dicing along the ACC edges 145 (FIG. 6). The epoxy coating 195 on the tape 190 holds the cells together during stacking (FIG. 10) or folding, and may provide a passivation/sealing layer on one side or surface of the stacked cells during packaging. Thus, the coated tape 190/195 may comprise a die attach film (DAF). Singulation may be conducted by laser dicing, but mechanical dicing and stamping are also possible. Exemplary mechanical dicing and stamping processes for this step are also disclosed in U.S. patent application Ser. No. 18/885,525, filed Sep. 13, 2024 (Atty. Docket No. IDR2022-06), the relevant portions of which are incorporated herein by reference. Thus, the epoxy coating 195 may also be cut during singulation, as may the tape 190. The redistribution layer 185b (FIG. 8) may be cut or separated to form redistribution layers 185ba and 185bb either during singulation or during removal (e.g., from a chuck or other deposition/patterning apparatus) at or near the end of the redistribution layer formation process.

Structures formed during an alternative process for printing the barrier and/or passivation layer and a conductive adhesive (e.g., in the openings in the barrier and/or passivation layer on an array of solid-state battery cells is shown in FIGS. 10-13B. The array is generally on the metal foil substrate, and the metal foil substrate may be in the form of a sheet or roll of the metal foil.

FIG. 10, for example, shows a plan (top-down) view of an array 200 of battery cells on a support (not identified, but similar or identical to the substrate 100 in FIG. 1). The battery cells include an uppermost pattern of ACCs 240aa-240gj, substantially as described herein with reference to ACCs 140a-d (FIG. 6). The ACCs 240aa-240gj may be printed or otherwise formed on a solid-state electrolyte layer 230, substantially as described for the ACCs 140a-d (FIG. 4) and electrolyte 130 (FIG. 3). Openings 255a-e (FIG. 10) penetrating the solid-state electrolyte layer 230 and underlying cathode (not shown), and exposing the support are shown in outline (dashed line) form, are formed substantially as described herein with reference to openings 155a-c (FIG. 6). However, a moat may or may not be formed in the alternative process shown in FIGS. 10-13B. In the exemplary structures shown in FIGS. 10-13B, a moat is not formed. The support may also include, or be similar, substantially identical or identical to, the tape or sheet 160 (FIG. 6) or the tape 190 (FIG. 9).

FIG. 11A shows the array 200′ of battery cells from FIG. 10 with a conductive paste 280aa-280gj on the ACCs 240aa-240gj. The conductive paste 280aa-280gj functions as a type of via or contact between the ACCs 240aa-240gj and an overlying redistribution trace to be formed later. The conductive paste 280aa-280gj may be printed on the ACCs 240aa-240gj by any of a variety of printing techniques (e.g., screen printing, inkjet printing, stencil printing, gravure printing, flexographic printing, etc.). The conductive paste 280aa-280gj may be cured (e.g., by heating or sintering) at a temperature of 150-400° C., or any temperature or range of temperatures therein (e.g., 150-300° C.), for a length of time sufficient to substantially convert the paste to the conductive bumps. Alternatively, curing may comprise irradiating with UV light, or a combination of irradiating with UV light and heating, as described herein. A method of printing a conductive paste or resin to form such conductive bumps is disclosed in U.S. patent application Ser. No. 15/750,481 (Atty. Docket No. IDR4470), filed Feb. 5, 2018 and entitled “Wireless Tags With Printed Stud Bumps, and Methods of Making and Using the Same,” the relevant portions of which are incorporated herein by reference.

The conductive paste 280aa-280gj may comprise an electrical conductor (e.g., filaments, flakes or a powder of a metal such as silver, nickel or copper, or of another electrically conductive material such as graphite or a solder) in a liquid or otherwise flowable medium. The flowable medium may comprise a varnish, a synthetic and/or adhesive resin such as an epoxy resin, a (meth)acrylate resin, a poly(alkylene oxide), ethyl cellulose or hydroxyethyl cellulose, or an adhesive silicone polymer, optionally in one or more organic solvents such as methanol, ethanol, isopropanol, 1-methoxypropan-2-ol, 1-ethoxypropan-2-ol, 1-methoxy-propan-3-ol, 1-ethoxypropan-3-ol, acetone, methyl ethyl ketone, methyl acetate, ethyl acetate, diethyl ether, methyl t-butyl ether, etc. Alternatively or additionally, the conductive paste may include a synthetic resin such as cellulose or a thixotropic agent such as castor oil, hydrogenated castor oil, an amide-modified castor oil derivative, a fatty amide, etc. In some embodiments, the conductive paste 280aa-280gj is a conductive adhesive paste or a solder. The solder generally comprises an alloy of tin and one or more alloying elements selected from bismuth, silver, copper, zinc, and indium. In other or further embodiments, the conductive paste 280aa-280gj is cured prior to the next step, thereby forming conductive bumps 282aa-282gj (FIG. 12A). A pattern 280 of the conductive paste is shown in FIG. 11B.

The bumps formed from the conductive paste 280aa-280gj may have a thickness of 0.1 to 50 μm (e.g., 0.3-10 μm or any value or range of values therein) and a diameter of 25 to 2000 μm (e.g., 50-1500 μm or any value or range of values therein) at half of the height (or thickness) of the bumps. The conductive bumps 280aa-280gj may have a radius at the base of 30 to 3000 μm (e.g., 60-2000 μm or any value or range of values therein). For example, when screen printed, the conductive bumps 280aa-280gj can be formed when the screen has holes or openings with a radius of 20 to 2000 μm (e.g., 50-1500 μm or any value or range of values therein).

FIG. 12A shows the array 200″ of battery cells from FIG. 11A with an insulator layer 270 on the ACCs 240aa-240gj and the electrolyte layer 230, as well as in the openings 255a-e and on the support exposed in the openings 255a-e. The insulator layer 270 may comprise or consist essentially of the same materials discussed herein for insulator layer 170 (FIG. 7). The conductive bumps 282aa-282gj, which may be cured, partially cured or uncured, remain exposed through openings in the insulator layer 270.

As shown in FIG. 12B, the insulator layer 270 is selectively deposited in a pattern that includes openings 275aa-275fj that correspond or substantially correspond to the conductive paste pattern 280 shown in FIG. 11B. A precursor material for the insulator layer 270 may be selectively deposited by any of the printing techniques described herein, but inkjet printing or aerosol-jet printing (either of which may apply, e.g., a sol-gel insulator precursor solution, as described herein or as otherwise known in the art), or screen printing (e.g., using a suspension of fine particles of an electrically insulating material such as silica, alumina, zirconia, titania, mixtures or combinations thereof, etc., in an organic solvent, optionally with a conventional binder), are particularly suitable. After printing, the precursor material may be conventionally cured to form the insulator layer 270. For example, the precursor material may be cured (e.g., by heating or sintering) at a temperature of 50-350° C., or any temperature or range of temperatures therein for a length of time sufficient to substantially convert the precursor material to the insulator.

In some embodiments, the openings 275aa-275fj in the insulator layer 270 have an area or diameter slightly larger than that of the conductive bumps 282aa-282gj. For example, the openings 275aa-275fj may have an area that is 1-50% larger than that of the conductive bumps 282aa-282gj, or a radius or diameter that is 1-20% larger than that of the conductive bumps 282aa-282gj.

FIG. 12C shows a cross-section of a single cell across the line C-C′in FIG. 12A, including conductive bump 282 on the ACC 240, with the insulator layer 270 surrounding the conductive bump 282 and covering the ACC 240, the other battery cell layers (i.e., electrolyte 230 and cathode 220), the barriers 215a-b and the substrate 210. The insulator layer 270 is on the battery cell sidewall in the opening 255. As shown in FIG. 12C, the conductive bump 282 has a bell-shaped cross-sectional profile, but other profiles, such as hemispherical, substantially hemispherical, cylindrical, square, rectangular (optionally with rounded corners), etc., are suitable. The cross-section in FIG. 12C is not drawn to scale, and the conductive bump 282 may have an aspect ratio (height-to-width or height-to-diameter ratio) that is <1:1, ≤1:2, ≤1:5, or any other value or range of values <1:1 (e.g., from 1:10 to 1:100).

The insulator layer 270 has a thickness less than that of the conductive bump 282. Ideally, the thickness of the insulator layer 270 is 40-80% of the thickness of the conductive bump 282. The greater the mass loading of the insulating material or insulator precursor in the material printed for the insulator layer 270, the closer that the thickness of the insulator layer 270 can be to the thickness of the conductive bump 282, as the thickness of the printed material for the insulator layer 270 (e.g., including solvent, binder, etc.) should also be less than the thickness of the conductive bump 282 to avoid the possibility of insulator material remaining on the entire uppermost surface of the conductive bump 282. In addition, the closer the thickness of the insulator layer 270 is to 100% of the thickness of the conductive bump 282, the less surface area of the conductive bump 282 is available for ohmic contact to an overlying conductor (e.g., a redistribution layer 285; see FIG. 13B). However, to ensure electrical isolation of the active battery layers along the ACC edge of the die, the insulator layer 270 should have a minimum thickness (which depends on many factors, such as the chemical identity of the insulator layer 270, the manner in which it is applied, the technique by which the die are diced, the materials of the substrate 210, the barriers 215a-b, the ACC 240, etc.).

FIG. 13A shows the array 200″ of battery cells from FIG. 12A with redistribution metal layers 285aa-285ge on the insulator layer 270 and the conductive bumps 282aa-282gj, as well as in the openings 255a-c. The redistribution metal layer 285aa-285ge is similar or substantially similar to the redistribution metal layer 185 described above with respect to FIG. 8, and may be formed by selective deposition, such as thermal evaporation (e.g., through a mask that exposes regions of the cells corresponding to the pattern of the redistribution layers 285aa-ge, followed by removal of the mask), inkjet printing, aerosol-jet printing or screen printing. When printed, the redistribution layers 285aa-ge may be deposited as a metal precursor in an ink or paste. The paste may be as described herein, and the ink may comprise a metal salt, compound or complex in one or more solvents such as water, an alcohol, a cyclic or acyclic ether or polyether (e.g., dimethoxyethane, diglyme), an alkoxysilane, a cyclic or acyclic ketone, a cyclic or acyclic ester, an amide (e.g., dimethyl formamide), a dialkyl sulfoxide (e.g., dimethyl sulfoxide), etc., and one or more optional additives (e.g., a mineral acid). Examples of such inks are disclosed in U.S. Pat. No. 8,066,805, the relevant portions of which are incorporated herein by reference. The redistribution layers 285aa-ge may be cured as described above for redistribution layer 185.

FIG. 13B shows a cross-section of a single cell in FIG. 13A, across the same line as line C-C′ shown in FIG. 12A, including the redistribution layer 285 on the conductive bump 282 and along the sidewall of the insulator layer 270. As shown in FIG. 13B, there may be some thinning of the redistribution layer 285 at the apex of the conductive bump 282.

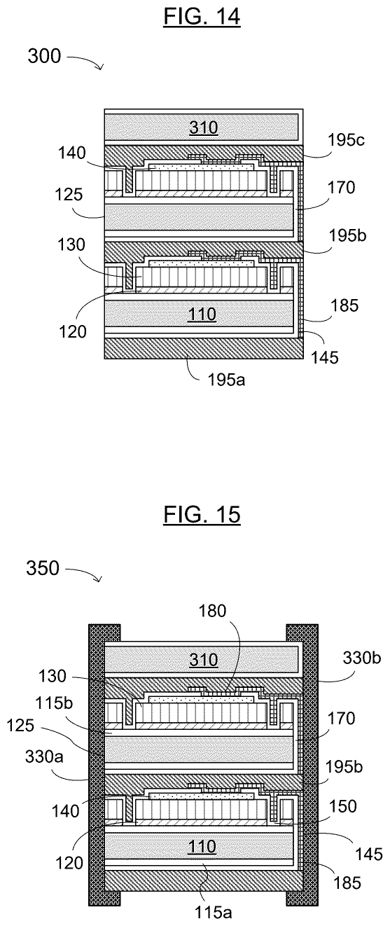

Following formation of the redistribution metal layer 285aa-285ge, the individual cells are singulated as discussed with respect to FIG. 9, and an adhesive may be printed on or applied to the battery cells, as discussed with respect to FIG. 14 below. The combined redistribution layer 285 and insulator layer 270 are relatively easily broken when separated from the support/carrier 290 (FIGS. 12C and 13B). The individual cells may be stacked and packaged as discussed below with respect to FIGS. 14-15.

FIG. 14 is a side or cross-sectional view of multiple ones of the battery cells of FIG. 9 in a stack, and FIG. 15 is a cross-sectional view of an exemplary packaged battery including the battery cell stack of FIG. 14 according to one or more embodiments of the present invention. However, the stacking and packaging techniques discussed with respect to FIGS. 14 and 15 also apply to singulated and/or folded battery cells as shown in FIGS. 13A-B.

As shown in FIG. 14, after removal of the cells from the tape 190, stacking forms a multi-layer set of parallel cells 300 with the CCC (substrate) edges 125 along one side of the stack, and the ACC edges 145a-d (including the ACC trace/redistribution layers 185) along the opposite side. The epoxy adhesion 195b-c between cells can be from the coated tape 190/195 (FIG. 9) or from a liquid die attach (DA) process, and can be applied to the back and/or front major surface of the cells, prior to or after cell singulation. If not applied as part of a DA process, the epoxy 195a-c can be applied by well-known methods such as b-stage laminated film formation, dispensing, jetting, inkjet printing, screen printing, etc. The stacked set of cells 300 forms a stacked solid-state battery. The parallel cells each additively contribute to the overall battery capacity.

Cell stacking may comprise a conventional pick-and-place technique. However, other stacking methods, such as strip folding, strip stacking, etc., before, after or in place of dicing are also acceptable. A dummy cell 310 (e.g., an encapsulated metal foil substrate, such as the metal foil, film or sheet 110 or substrate 100 in FIG. 1, encapsulated with an insulator as described with respect to FIG. 7) may be placed on top of the stack 300 as a moisture and air barrier and to protect the stack 300 from externally-caused damage. Optionally, markings on one major surface of the dummy cell 310 can be used as external product markings.

Alternatively, when the cells are singulated as cell pairs or as 1×n strips (e.g., columns) of cells (where n is a positive integer of 3 or more, such as 4, 6, 8, 10, 12, 16, etc.), adhesive layers 195 may be applied to cell pairs or cell strips, and the cells pairs or cell strips may be folded. Exemplary processes and structures for folded strips of cells are disclosed in U.S. patent application Ser. No. 17/185,122, filed Feb. 25, 2021 (Attorney Docket No. IDR2020-02) and U.S. Prov. Pat. Appl. No. 63/598,912, filed on Nov. 14, 2023 (Atty. Docket No. IDR2022-10-PR), the relevant portions of each of which are incorporated herein by reference. Singulated cell pairs can be folded in accordance with U.S. patent application Ser. No. 17/185,122 and U.S. Prov. Pat. Appl. No. 63/598,912, then packaged using an exemplary process disclosed in U.S. Pat. No. 11,735,791, the relevant portions of which are incorporated herein by reference.

Battery terminal dipping and plating the stacked set of cells 300 forms external electrical contacts 330a-b, as shown in FIG. 15. End terminals at the CCC and ACC edges 125 and 145 (e.g., the exposed edges of the CCCs 110 and the redistribution layers 185, respectively) are dipped into or coated with a conductive epoxy to electrically gang the terminals and form the CCC terminal 330a and ACC terminal 330b of the packaged battery. The conductive epoxy may comprise an Ag-filled or Ni-filled conductive epoxy paste. Alternatively, a pin-to-pin paste transfer method may be used, or a stable and/or noble metal such as Au, Pt, Pd or Cu can be used in place of the Ag or Ni. Plating a metal onto part or all of the CCC terminal 330a and ACC terminal 330b creates a solderable surface for PCB attachment by the end user. For solderable termination, the epoxy surface may be plated with Ni, Ag, In, Sn, or a combination thereof (e.g., Ni, then with In or Sn).

In some embodiments, the conductive epoxy 330a-b contains a relatively high metal content, which can retard ambient ingress (e.g., of oxygen or water vapor). The epoxy 330a-b may be plated with one or more pure metal layers, to further block ambient ingress. Both of these features help with ambient air and moisture resistance, particularly on the CCC edge 125, due to the barrier/insulation film 170 being unapplied or diced at this edge during cell singulation from the cell pairs (FIG. 9).

### Conclusion

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

1. A solid-state battery cell, comprising:
a substrate;
a cathode on or over the substrate;
a solid-state electrolyte on the cathode;
an anode current collector (ACC) on the solid-state electrolyte;
a conductive bump on the ACC;
an insulator layer on the ACC and having a sidewall portion on a sidewall of each of the ACC, the solid-state electrolyte, the cathode and the substrate, wherein the insulator layer surrounds the conductive bump and exposes a surface of the conductive bump; and
a conductive redistribution layer in ohmic contact with the conductive bump and on the insulator layer, including the sidewall portion.

2. The solid-state battery cell of claim 1, wherein the conductive bump has a height, and the insulator layer has a thickness smaller than the height of the conductive bump.

3. The solid-state battery cell of claim 1, wherein the substrate comprises a metal foil, film or sheet.

4. The solid-state battery cell of claim 4, wherein the substrate comprises the metal foil, and the metal foil has a thickness of 0.1-100 μm.

5. The solid-state battery cell of claim 4, wherein the substrate further comprises a barrier on one or more major surfaces of the metal foil, film or sheet, and the barrier has a thickness effective to prevent migration of atoms or ions from the metal foil into overlying layers.

6. The solid-state battery cell of claim 1, wherein the cathode comprises a lithium metal oxide or lithium metal phosphate, the solid-state electrolyte comprises a lithium phosphorus oxynitride or Li₂WO₄, and the ACC comprises nickel, zinc, copper, an alloy thereof, or graphite.

7. The solid-state battery cell of claim 1, wherein the conductive bump comprises an electrically conductive metal or solder, or an electrically conductive graphite.

8. The solid-state battery cell of claim 1, wherein the insulator layer comprises a polyolefin and/or an inorganic oxide layer.

9. The solid-state battery cell of claim 1, further comprising a moat in the cathode and the solid-state electrolyte, surrounding the ACC and configured to physically separate an active portion of the battery cell from a peripheral dummy region of the battery cell.

10. A packaged solid-state battery, comprising:
a plurality of the solid-state battery cells of claim 3;
an adhesive layer between adjacent ones of the solid-state battery cells;
a first terminal in electrical contact with the conductive redistribution layer on the sidewall portion of the insulator layer; and
a second terminal in electrical contact with an exposed surface of the substrate.

11. A method of making a solid-state battery cell, comprising:
printing a conductive bump on an anode current collector (ACC) on a solid-state electrolyte, wherein the solid-state electrolyte is on a cathode, and the cathode is on or over a substrate;
printing an insulator layer on the ACC and on a sidewall of each of the ACC, the solid-state electrolyte, the cathode and the substrate, such that the insulator layer surrounds the conductive bump and exposes a surface of the conductive bump; and
forming a patterned conductive redistribution layer on the exposed conductive bump and the insulator layer, including a portion thereof along the sidewalls of the ACC, the solid-state electrolyte, the cathode and the substrate, such that the conductive redistribution layer is in ohmic contact with the conductive bump.

12. The method of claim 11, wherein printing the conductive bump comprises screen printing, inkjet printing, stencil printing, gravure printing, or flexographic printing a conductive paste, resin or solder, and curing the conductive paste, resin or solder to form the conductive bump.

13. The method of claim 11, wherein the insulator layer is printed in a pattern on the ACC and the sidewall of each of the ACC, the solid-state electrolyte, the cathode and the substrate, the pattern comprising an opening having an area larger than that of the conductive bump.

14. The method of claim 11, wherein forming the patterned conductive redistribution layer comprises:
sputtering, atomic layer deposition (ALD) or thermal evaporation of an air-and/or water-stable metal through a mask, and removing the mask;
blanket depositing an air-and/or water-stable metal on the exposed conductive bump and the insulator layer, photolithographically patterning the metal, and etching the metal; or
selectively depositing the patterned conductive redistribution layer on the exposed conductive bump and the insulator layer.

15. The method of claim 14, wherein the patterned conductive redistribution layer is selectively deposited on the exposed conductive bump and the insulator layer by a process comprising inkjet printing, aerosol-jet printing or screen printing an ink or a paste of a precursor of the conductive redistribution layer, and curing the ink or the paste.

16. The method of claim 11, wherein the conductive redistribution layer comprises an air- and water-stable, lithium-compatible metal.

17. The method of claim 11, further comprising patterning the ACC prior to printing the conductive bump.

18. The method of claim 11, further comprising blanket-depositing the cathode on or over the substrate, blanket-depositing the solid-state electrolyte on the cathode, and forming the ACC on the solid-state electrolyte.

19. The method of claim 18. wherein forming the ACC comprises forming a patterned ACC.
